(19) United States
(12) Patent Application Publication
(10) Pub. No.: US 2025/0187267 A1
(43) Pub. Date: Jun. 12, 2025

(54) METHOD AND MACHINE FOR ADDITIVE MANUFACTURE

(71) Applicant: GALEA 3D PRINTING, Saulny (FR)

(72) Inventor: Hervé Gori, Saulny (FR)

(21) Appl. No.: 18/712,943

(22) PCT Filed: Nov. 18, 2022
(86) PCT No.: PCT/EP2022/082516

§ 371 Date: Oct. 14, 2024

(30) Foreign Application Priority Data
Nov. 24, 2021 (FR) FR2112473

(51) Int. Cl. B29C 64/245; B29C 64/118; B29C 64/188; B29C 64/295; B29C 64/35; B29K 105/12

(52) U.S. Cl. CPC B29C 64/245; B29C 64/118; B29C 64/188; B29C 64/295; B29C 64/35; B29K 2105/12

(57) ABSTRACT

A method for additive manufacture of a part, in which the part is manufactured by printing successive layers of thermoplastic material, in which a plurality of individual layers of thermoplastic material are formed by fused filament deposition on a plurality of transfer supports. The individual layers are transferred by successively applying each transfer support to the part in the course of manufacture in order to deposit the individual layer supported by the transfer support. The method of manufacture can be machine implemented.

### TECHNICAL FIELD

The invention concerns a process for additive manufacturing by depositing a fused filament. It also concerns a machine designed to implement this process.

### PRIOR ART

3D printing in its current state makes it possible to obtain a three-dimensional part by creating successive layers of different materials. A nozzle for injecting a thermoplastic material in the molten state moves with respect to a platen and deposits the material in the form of a filament to create layers. The layers are superposed to form the end part.

This process has the drawback of being very slow and the adhesion between the different layers is relatively poor. Furthermore, it does not offer any real perspective for industrialization, owing to the great number of manipulations required between each part.

### DESCRIPTION OF THE INVENTION

The purpose of the invention presented is to overcome these different drawbacks. It aims in particular to provide a high-productivity three-dimensional printing process. It also aims to provide a machine for implementing this process.

With these goals in mind, the object of the invention is an additive process for manufacturing a part, whereby the part is made by printing successive individual layers of thermoplastic material, characterized by the fact a plurality of individual layers of thermoplastic are made by depositing a fused filament on a plurality of transfer supports and said individual layers are transferred by successively applying each transfer support on to the part being made to deposit the individual layer supported by said support.

Thus, this process makes it possible to manufacture layers separately, and then assemble these layers to form a three-dimensional part. The different layers can be manufactured separately and in parallel on the plurality of transfer supports, each of these phases being long when taken individually. The time required to assemble an individual layer on the part is relatively short. The layer manufacturing time is thus divided by the number of layers that can be manufactured simultaneously, compared with the conventional process. Furthermore, it is possible to exert a pressure on the individual layer to press it onto the part during the transfer, which makes it possible to guarantee a good weld between layers. Here, we propose a process that is at least forty times faster with a strength between layers greatly improved by a factor of 10 at least. Furthermore, this process can be industrialized enabling printing speeds in this configuration that could be up to five hundred times faster while occupying less space and requiring fewer people to manage it.

As per a constructive provision, the transfer support is made of metal, glass or borosilicate. These materials can withstand high temperatures without being deformed and offer the possibility of detaching the individual thermoplastic layer without great difficulty.

As per an advantageous provision, the transfer support is cylindrical or cylindrical in part. This facilitates the deposit of the individual layer simply by rotating the support above the part. Likewise, the manufacture of the individual layer is controlled, in particular, by the rotation of the support around the axis of the cylinder.

As per another accomplishment mode, the transfer support is supple so that it can be made cylindrical or take a shape enabling a linear contact on the part. The suppleness of the support makes it possible to envisage a support shape during the manufacture of the layer that is distinct from that during the transfer of the layer to the part.

As per an improvement, a flocking of fibres is deposited on the individual layer before it is deposited on the part. The fibres thus deposited make it possible to reinforce the cohesion of the part by creating a reinforcement of the join between layers. The flocking, particularly when is it is done electrostatically, makes it possible to direct the fibres perpendicularly to the surface of the of the layer in a direction which is favourable to the join between layers.

As per an improvement, the contact zone between the part and the individual layer is heated locally to obtain a local fusion of the individual layer and of the surface of the part to weld the individual layer to the part. The heating is applied just before assembly so that a weld is thus made. The heating could be accomplished by sweeping a laser beam for example.

As per an improvement, the transfer support is cooled from the inside during the layer depositing phase to enable the separation of the individual layer from the transfer support. We make sure that the layer deposited on the part no longer adheres to the transfer support but remains on the part. Cooling also makes it possible to ensure the solidification of the layer deposited on the part.

Advantageously, the thickness of the individual layer is comprised between 0.05 and 3 mm, preferably between 0.05 and 1 mm.

Preferably, the preliminary layer's thermoplastic material includes a filler. We thus obtain a part with good mechanical properties. The filler can be made of fibres of different types: polyamide, carbon, carbon nano-fibres, metal. The filler can also be a powder.

Preferably, the thermoplastic material should be chosen from a group comprising PLA, PEEK, ABS, polyamide, polyetherimide (PEI), PETG and PMMA.

The object of the invention is also an additive manufacturing machine comprising a platen to receive a part built by printing successive layers of thermoplastic material, characterized by the fact it includes a plurality of layer units, each layer unit being designed to make an individual layer of thermoplastic material by depositing a fused filament on a transfer support, a gripping unit for transferring the transfer supports to a printing unit, which is configured to transfer said individual layers by successively applying each transfer support to the part being manufactured to deposit the individual layer. Each layer unit receives a transfer support and makes an individual layer on the support, preferably offset in time between the different layer units. The transfer supports are then taken by the gripping unit to be transferred successively to the printing unit. There, each of the individual layers is deposited on the part being manufactured.

As per an improvement, the printing unit includes a barrel supporting some of the transfer supports to move them between stations, including at least one input station for receiving the transfer support arriving from a layer unit, an output station for storing the transfer support intended for a layer unit and a transfer station in which the individual layer is deposited on the part.

As per an improvement, the barrel also includes a flocking station upstream of the transfer station configured to deposit a fibre flocking on the individual layer. The flocking is added just before the layer is deposited on the part.

As per an improvement, the barrel includes a cleaning station. If the cleaning station is placed downstream of the transfer station, the residues from the previous operation can be eliminated from it. The cleaning upstream of the transfer station may concern the extraction of residues to prevent them from being deposited on the part.

As per an improvement, the barrel includes an inspection station. The quality of the geometry and of the surface of the transfer supports, or the quality of the individual layer before it is deposited can be checked there.

As per a constructive provision, the plurality of the layer units are grouped together in one or more stores. Each store can be interfaced with the gripping means, and the number of stores can be modulated in line with the desired level of machine productivity.

As per an improvement, the machine includes a laser for heating the parts common to both layers enabling the bonding of the layer to the part.

### BRIEF DESCRIPTION OF THE FIGURES

The invention will be better understood and other special features and advantages will appear on reading the following description, said description referring to the appended drawings among which:

FIG. 1 is a sectional view of a machine conform to a first accomplishment mode for the invention;

FIG. 2 is a perspective view of a layer unit used in the machine shown in FIG. 1;

FIG. 2b is a longitudinal sectional view of the layer unit shown in FIG. 2;

FIG. 2c is a transversal sectional view of the layer unit shown in FIG. 2;

FIG. 2d is a schematic view of a variant of the layer unit shown in FIG. 2;

FIG. 3 is a perspective view of a store including a plurality of layer units as per FIG. 2;

FIG. 4 is a perspective view of a gripping device used to move the transfer supports;

FIG. 5 is a perspective view of a printing unit used in the machine shown in FIG. 1;

FIG. 6 is a schematic view of a flocking station for the printing unit shown in FIG. 5;

FIG. 6a is a view of a filament used to manufacture the layers in the layer units;

FIG. 6b shows a layer with a plurality of filaments laid parallel to each other;

FIG. 6c shows a superposition of interwoven layers;

FIG. 6d shows a superposition of layers with fibres deposited by flocking;

FIG. 7 is a perspective view of the printing unit with a part being manufactured;

FIG. 8 is a perspective view of a series of machines conform to the invention;

FIG. 9 is a sectional view of a part manufactured as per a variant of the process.

### DETAILED DESCRIPTION

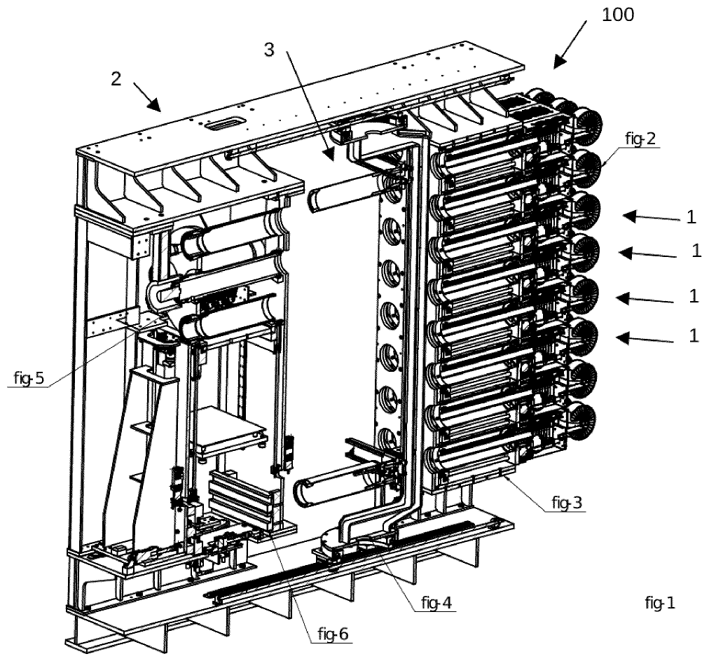

The invention shown in FIG. 1 consists of a store of 100 layer units 1 printing a single individual layer 42 on a cylinder 14 forming a transfer support which may be made of borosilicate glass or another material. These cylinders 14 are taken by a manipulator 3, such as shown in FIG. 4, forming a gripping device, which places them in a printing unit such as shown in FIG. 5. The printing unit 2 will make it possible to apply an individual layer 42 on a printing platen 25 managed by platen 25 manipulator such as shown in FIG. 7. The printing unit 2 will also make it possible to improve the strength between layers, ensure maintenance of the cylinders 14, inspection of the layers 42 and other possible functions.

Some or even all of the layers 42 comprising the final three-dimensional part 41 are printed simultaneously with an offset of a few seconds corresponding to the cycle required by the printing unit 2.

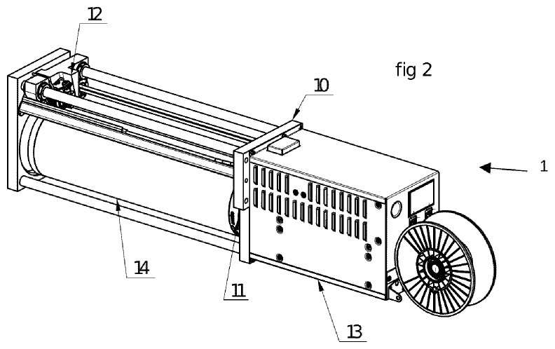

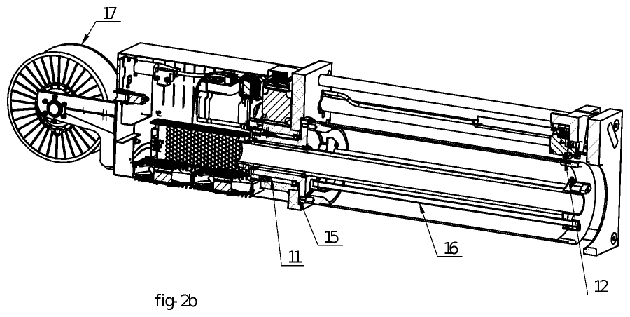

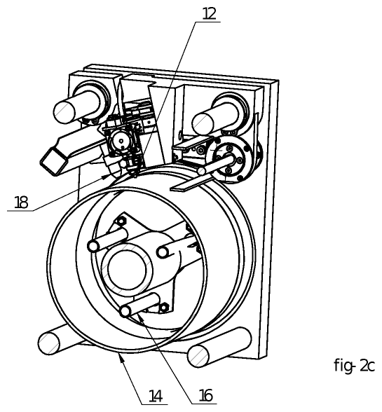

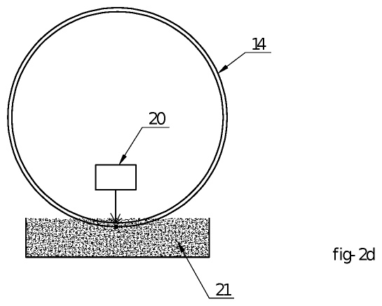

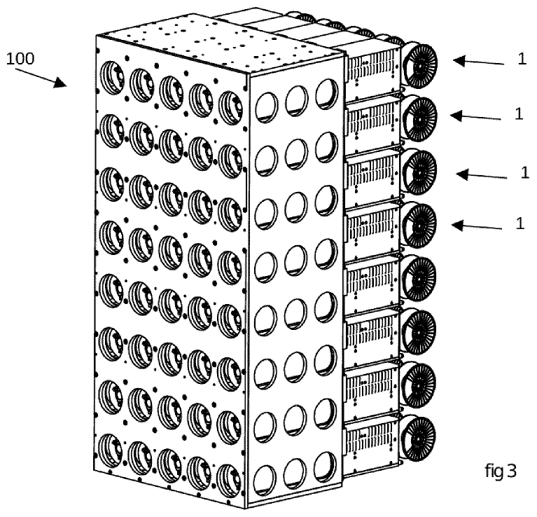

Each layer unit 1 consists of a frame 10, a rotary chuck 11 indexed per an X axis, a printhead 12 on a linear guide extending along a Y axis. Each layer unit 1 is independent and has its own electronic control system, cylinder 14 mapping management and material feed 13. Cylinder 14 is maintained magnetically by magnets 15 for easy extraction by the manipulator 3. A rotary heater 16 heats the cylinder 14 from the inside to guarantee the adhesion of the individual layer 42. Each layer unit 1 has a material feed which may be a reel of filament, but also a pellet or powder feed. The process presented prints the layer using the heated filaments, but it is also possible to hot-cure or agglomerate a layer on a cylinder 14 by means of a laser 20 inside the cylinder 14 with a bed of powder 21 under the cylinder 14, as shown in FIG. 2d. The process makes it possible to print in colour. To do this, an inkjet printhead 18 is installed next to the 3D printhead 12, and when printing of the individual layer 42 has been completed, the contour receives an inkjet imprint giving the end model its colour, in conjunction with the utilization of a white filament. The colouring of the horizontal parts is done on the printing unit 2. The colouring is also applied to the process on a bed of powder and laser shown in FIG. 2d. These layer units 1 are brought together in the 100-unit store, as shown in FIG. 3, whose temperature can be regulated to guarantee printing quality. Each printer can be fitted with one or more 100-unit stores.

The manipulator 3, double gripper, such as shown in FIG. 4, ensures the transfer of the cylinders 14 from the layer units to the printing unit 2 by transferring one incoming cylinder 14 and one outgoing cylinder 14.

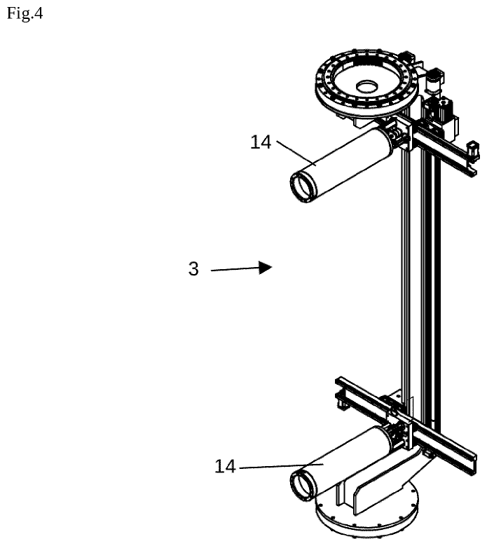

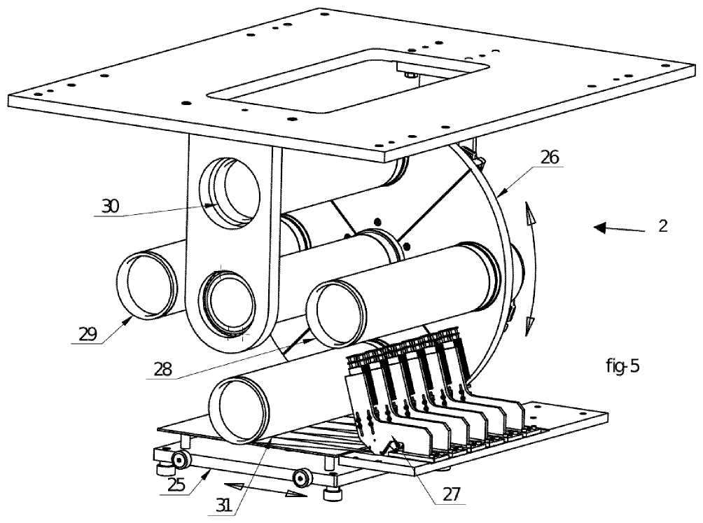

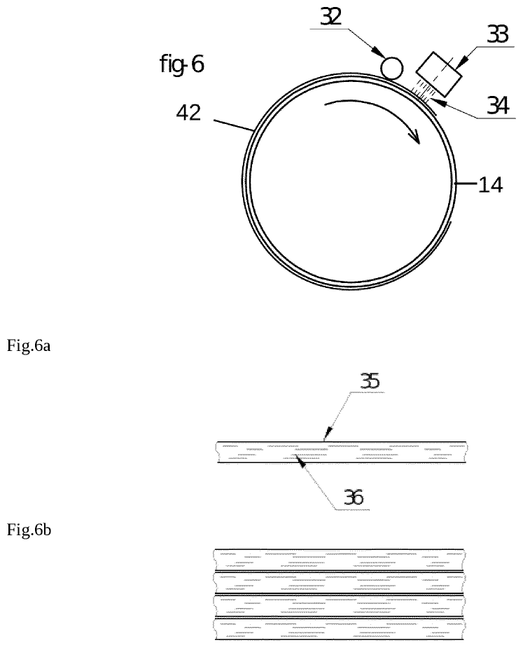

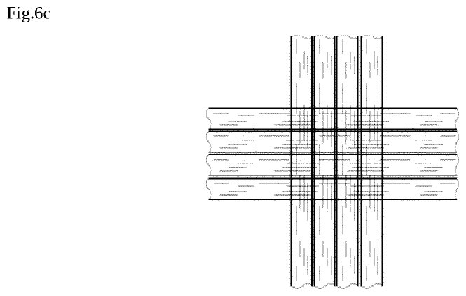

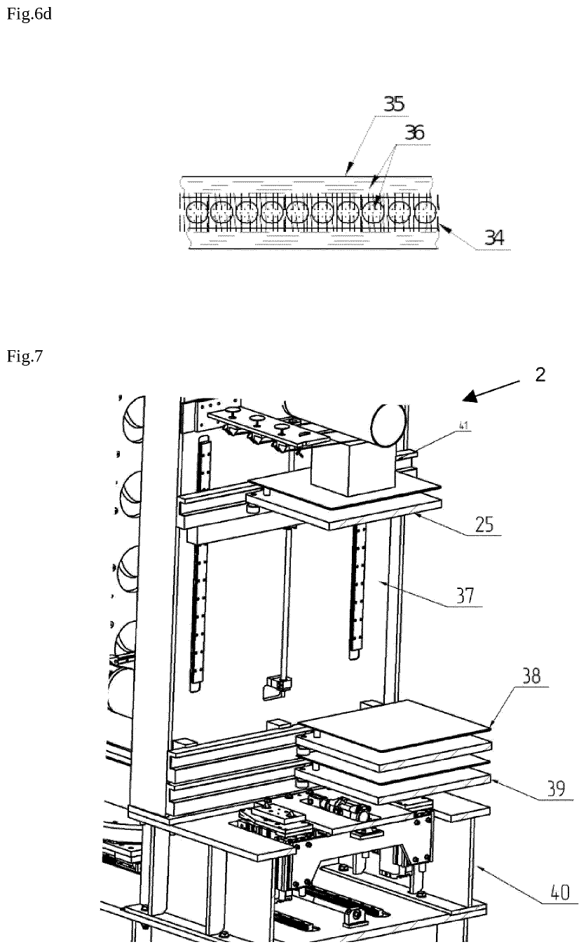

The printing unit 2, as shown in FIG. 5, consists of a barrel 26 that can receive several cylinders 14. The purpose of this printing unit 2 is to transfer the printed individual layer 42 present on the cylinder 14 directly to the platen 25 for the first layer and on to the part 41 formed by the previous layers for the following layers. The print transfer is done by synchronizing the speeds of the platen 25 and of the cylinder 14, by cooling inside the cylinder 14 to enable the separation of the layer 42 on the contact tangent 31 with the platen 25 and reheating the layers in contact by means of a laser 27. This laser 27 only reheats the parts common to both layers enabling the layer to be bonded to the part 41. The barrel 26 may comprise several positions including a cylinder 14 input station 30 and output station 28. In addition, it may have a layer inspection station, a cylinder 14 maintenance and cleaning station and one or more layer improvement stations, including a flocking station 29 such as detailed in FIGS. 6 to 6d upstream of the depositing of the individual layer on the part 42.

This flocking station 29 consists of a reheater 32 of the individual layer 42 that softens the individual layer 42 ahead of the electrostatic flocking device 33 with deposits short fibres 34 perpendicularly on the layer, greatly improving the strength between the layers. These fibres may be of several types: nylon, polyamide, carbon, carbon or metallic nanofibre. The fibres 35, as shown in FIG. 6a in the carbon-charged printable filaments 36 are parallel to the direction of the filament, which is due to the extrusion of the filament manufacturing process. Likewise in the printed individual layer 42, shown in FIG. 6b, which gives the model strength in the filament direction and in the weft direction (X and Y) owing to the superposing of the layers shown in FIG. 6c, without the slightest effect on the Z axis, that is to say the axis ensuring the link between layers. In the inter-layer flocking process, as shown in FIG. 6d, the fibres 34 reinforce the strength in the Z axis between the layers.

A platen manipulator, shown in FIG. 7, ensures the management of the X and Z axis of the layer deposit under the printing unit 2, and also the transfer of the platen 25 from one printer to the other in the case of an industrial configuration. The upper part 37 is used for the transfer of the parts during printing. The finished models are moved in the lower part 38, the lower handling device 39 is used to feed the blank platens. The movement between the different levels is ensured by means of the manipulator 40.

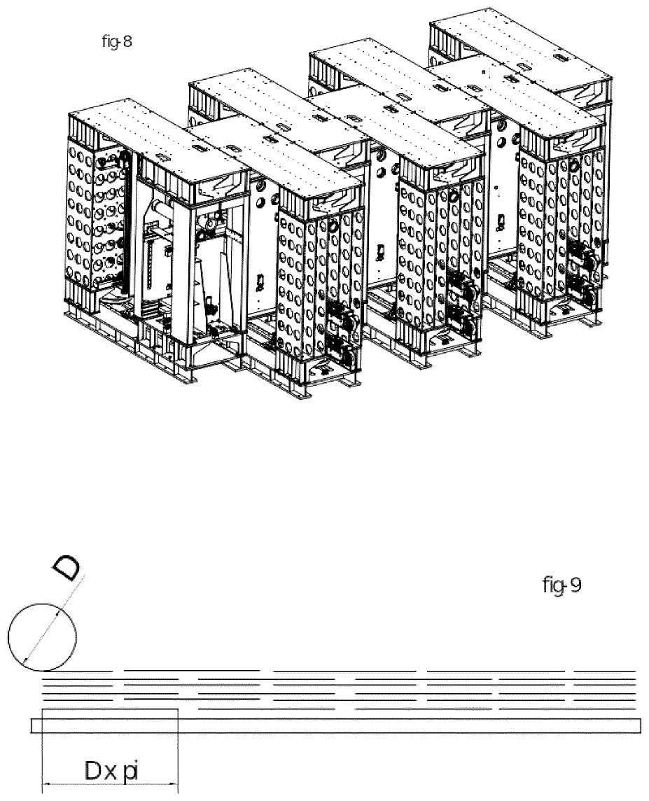

In an industrial configuration shown in FIG. 8, the printers are placed adjoining each other so that the handling of the platens ensures the transfer of the platens from one printing unit 2 to the other, which makes it possible to obtain a line with more layer units 1 without any manipulation intervention. Furthermore, this provision makes it possible, for example during the production of a series of parts, to start production of a part 41 or series of parts without disrupting the current production. Which gives the invention greater flexibility. This also makes it possible to use oversized platens with 1 to 4 times the capacity on X to create larger parts by offsetting layers FIG. 9, that is to say 1 to 4 or more times the cylinder's development.

What is claimed is:

1. A process for the additive manufacture of a part, whereby the part is manufactured by printing successive layers of thermoplastic material, whereby a plurality of individual layers of thermoplastic material is formed by depositing a fused filament on a plurality of transfer supports and said individual layers are transferred by successively applying each transfer support to the part currently being manufactured to deposit the individual layer supported by said transfer support, wherein the transfer support is cylindrical or partly cylindrical or the transfer support is supple in such a way that it can be made cylindrical or with a shape enabling a linear contact on the part.

2. The process according to claim 1, whereby the transfer support is made of metal, glass or borosilicate.

3. The process according to claim 1, whereby a fibre flocking is deposited on the individual layer before being deposited on the part.

4. The process according to claim 1, whereby local heating is applied to the contact zone between the part and the individual layer to obtain a local fusion of the individual layer and the surface of the part to weld the individual layer to the part.

5. The process according to claim 4, whereby the local heating is ensured by the sweep of a laser beam.

6. The process according to claim 1, whereby the transfer support is cooled from the inside during the layer depositing phase to enable the separation of the individual layer from the transfer support.

7. The process according to claim 1, whereby the individual layer has a thickness of from 0.05 to 3 mm, preferably of from 0.05 to 1 mm.

8. The process according to claim 1, whereby the preliminary layer's thermoplastic material includes a filler.

9. The process according to claim 1, whereby the thermoplastic material is chosen from a group comprising PLA, PEEK, ABS, polyamide, polyetherimide (PEI), PETG and PMMA.

10. An additive manufacturing machine comprising a platen for receiving a part built by printing successive layers of thermoplastic material, a plurality of layer units, each layer unit being designed to manufacture an individual layer of thermoplastic material by depositing fused filaments on a transfer support, a gripping unit for transferring the transfer supports to a printing unit, which is configured to transfer said individual layers by successively applying each transfer support on the part currently being manufactured to deposit the individual layer, wherein the transfer support is cylindrical or partly cylindrical or the transfer support is supple such that it can be made cylindrical or with a shape enabling a linear contact on the part.

11. The machine according to claim 10, in which the printing unit comprises a barrel supporting certain transfer supports for moving them between different stations, including at least one input station for receiving the transfer support arriving from a layer unit, one output station for storing the transfer support to be sent to a layer unit and one transfer station in which the individual layer is deposited on the part.

12. The machine according to claim 11 in which, upstream of the transfer station, the barrel also comprises a flocking station configured to deposit a fibre flocking on the individual layer.

13. The machine according to claim 11, in which the barrel comprises a cleaning station.

14. The machine according to claim 11, in which the barrel comprises an inspection station.

15. The machine according to claim 10, in which the plurality of layer units are grouped together in one or more stores.

16. The machine according to claim 10, wherein a laser is used for heating the parts common to the two layers to achieve bonding of the layer to the part.
